(19) United States
(12) Patent Application Publication
(10) Pub. No.: US 2005/0076050 A1
(43) Pub. Date: Apr. 7, 2005

(54) Method and program product for creating data records

(75) Inventor: David Nicholas Wilcockson, Northamptonshire (GB)

Correspondence Address: GREER, BURNS & CRAIN, 300 S WACKER DR, 25TH FLOOR, CHICAGO, IL, 60606, US

(73) Assignee: Librios Research Limited

(21) Appl. No.: 10/680,837

(22) Filed: Oct. 7, 2003

(51) Int. Cl. G06F 17/30

(52) U.S. Cl. 707/102

(57) ABSTRACT

A method for creating and retrieving data records includes steps of organizing categories across a plurality of hierarchical levels, and of assigning category identifiers to each of the categories. The category identifiers embody implicit knowledge regarding the placement of the category identifier within the hierarchical arrangement. Data entries are then provided with data records, each of the data records including at least one of the category identifiers. When a query that includes a category identifier is processed, a data record is retrieved that includes the category identifier.

### FIELD OF THE INVENTION

The present invention is related to systems, methods and computer program products for creating data records, as well as to systems, methods and program products for retrieving data records.

### BACKGROUND OF THE INVENTION

The need for data management tools that create and retrieve data records has steadily increased as businesses and other users around the world put greater importance on the collection and organization of data. Data may be digital in format for storage on processor-based devices such as computers. Management of the data may include organizing the data for relatively fast and convenient retrieval as desired. Database computer programs are an example of a data management tool. A database may provide a framework for entering, organizing, and retrieving data.

Some databases may also provide data relation capabilities. Through data relation capabilities, information regarding the relationships and dependencies between data may be stored and manipulated. By way of example, data may be classified into categories, and categories related to one another. A hierarchical structure can be used to organize categories. By way of illustration, a particular example may be a database containing wine data. One category of data may be wine names, with a number of subcategories such as price, type, geographical origin, etc. associated with each category. Further, a number of sub-subcategories could be associated with each category. For instance, a subcategory of “wine type” could include further categories of wine color, “wine classification”, “wine vintage”, etc.

Although methods and systems such as computer databases are known for performing these functions, there are many unresolved needs in the art. As an example, known databases tend to use complicated schemes for describing relations between data entries and categories. Data relations and structure may be organized in a logic “tree structure.” A general tree structure of the prior art is shown in FIG. 1 for wine. The logical tree structure of FIG. 1A is useful to organize data in a hierarchical fashion according to geographical origin, price, and type. While a tree approach may be relatively straightforward in theory, it can be difficult to apply in practice. For example, it may be desired to relate types of wine with geographical origin as well as price range. This is shown in FIG. 1B using dashed lines. Clearly, applying these relations within a logical tree framework can be a difficult and complicated process. In a computer program environment, such a task adds time and expense to the task. Also, relatively high demands may be placed on computer processor and memory resources.

Unresolved needs therefore exist in the art.

### SUMMARY OF THE INVENTION

Embodiments of the present invention are directed to systems, methods and program products for creating and retrieving data records. One exemplary embodiment is a method that has steps of organizing a plurality of categories into a plurality of hierarchical levels and assigning a category identifier to each of the plurality of categories. The category identifier for each respective category includes the identifier for each category linked to the respective category on one of the hierarchical levels that is above the level of the respective category. The exemplary method further includes the step of creating a data record for each of a plurality of data entries, with each of the data entries having at least one attribute that corresponds to one of the categories. The category identifier that corresponds to the category of the attribute is stored in the data record of the particular data entry. The method embodiment further includes steps of receiving a query that corresponds to one or more of the categories, and of retrieving at least one of the data records that include a category identifier corresponding to the category of the query.

In additional embodiments of methods and program products of the invention, the categories may be weighted. In still additional invention embodiments, queries are received from identified users, and categories are weighted on an individual user basis. Preferred examples of the invention comprise computer program products.

These and other aspects of the invention will be more fully described in the figures and detailed description that follows.

### BRIEF DESCRIPTION OF THE DRAWINGS

FIGS. 1A and 1B illustrate a hypothetical logical tree structure of the prior art;

FIG. 2 is a flowchart illustrating one exemplary method of the invention;

FIG. 3 is a schematic useful for illustrating the exemplary method of FIG. 2; and

FIG. 4 is the schematic of FIG. 3 with weighting added to some categories.

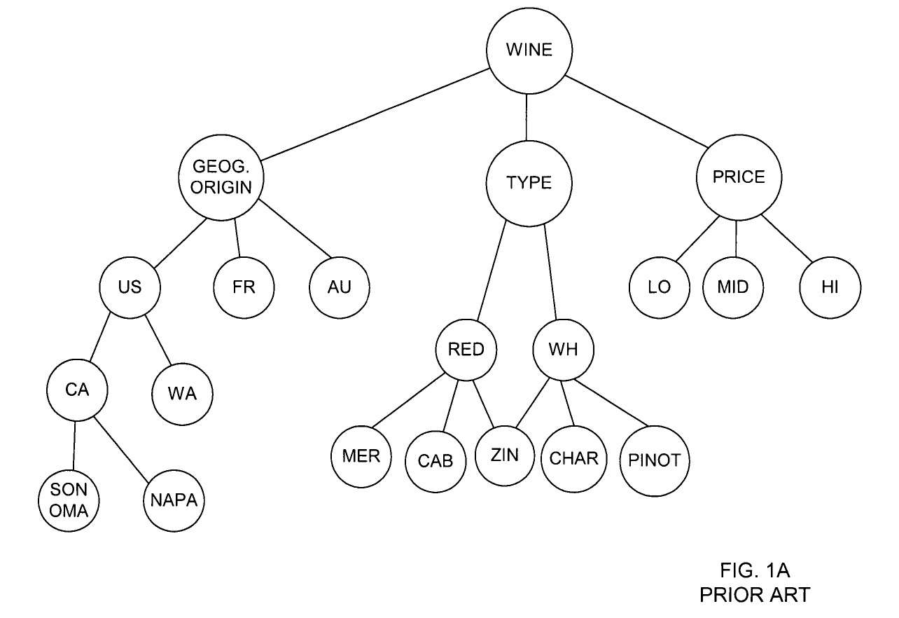

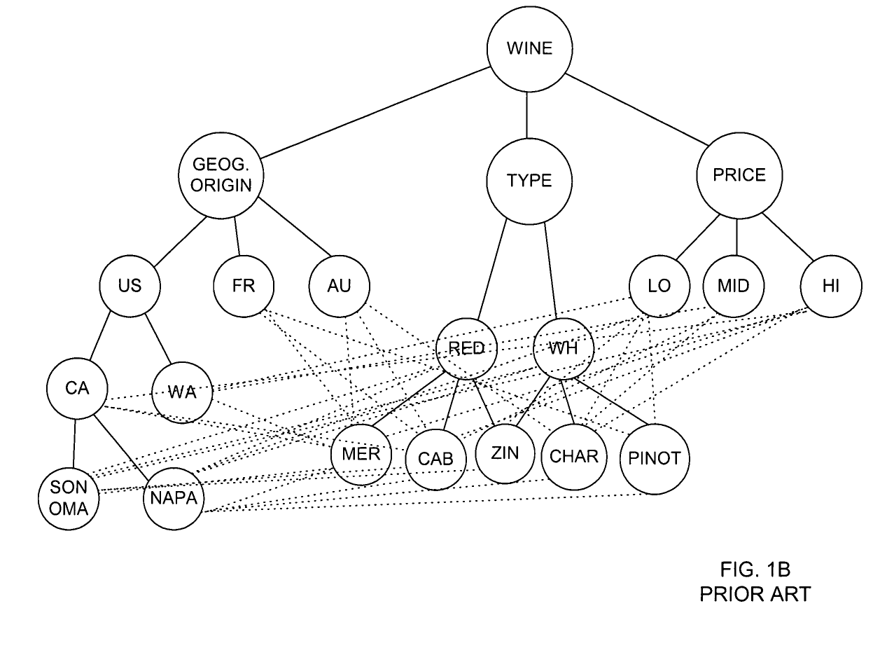

### DETAILED DESCRIPTION

The present invention is directed to systems, methods and program products for creating and retrieving data records. Embodiments of the invention provide advantages and benefits in their ability to store implicit knowledge in individual data records, and in their ability to leverage this implicit knowledge to model relationships between individual data entries. Before describing exemplary embodiments of the invention in detail, it will be appreciated that the present invention may be embodied in methods, in computer program products, and in computer systems.

By way of example, a computer program product of the invention may include computer executable instructions stored in a computer readable medium that when executed by a computer cause the computer to carry out steps of a method of the invention. Further, the present invention may be embodied in a computer system that is executing a program product of the invention. Accordingly, it will be appreciated that description herein of a method of the invention will likewise apply to a computer program product and a computer system of the invention. Likewise, description of a computer program product will be understood to be applicable to a computer system and a method of the invention.

### EXAMPLE 1

### Wine Classification

Operation of an exemplary embodiment of the present invention may be illustrated through a relatively simple example. This exemplary embodiment of the invention is directed to a method and program product for creating and retrieving data records describing various attributes of wines. It will be understood that as used herein the term “data record” is intended to be broadly interpreted as one or more items of information. The wines are described as follows:

TABLE 1
Example Wines

| Wine: | Description: |
|---|---|
| Wine1 | is a cheap sherry from Germany or from Paris |
| Wine2 | is an expensive port from France. |
| Wine3 | is a midprice cabernet from California |
| Wine4 | is an expensive merlot from Napa Valley. |

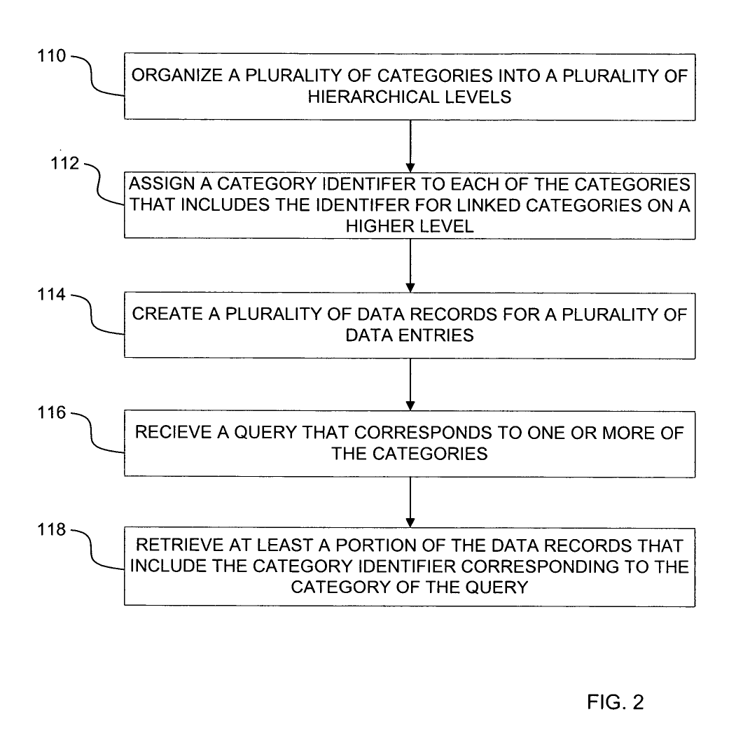

FIG. 2 is a flowchart of an exemplary method of the invention for creating and retrieving data records based on these wines. A plurality of categories are first arranged into a plurality of hierarchical levels (block 110). As used herein, the term “categories” is intended to be broadly interpreted as a type of data, and the term “hierarchical levels” is intended to be broadly interpreted as an ordered relation. An example of a category may be wine price, and an example of hierarchical levels may include sets and subsets such as California (set) and Napa Valley (subset).

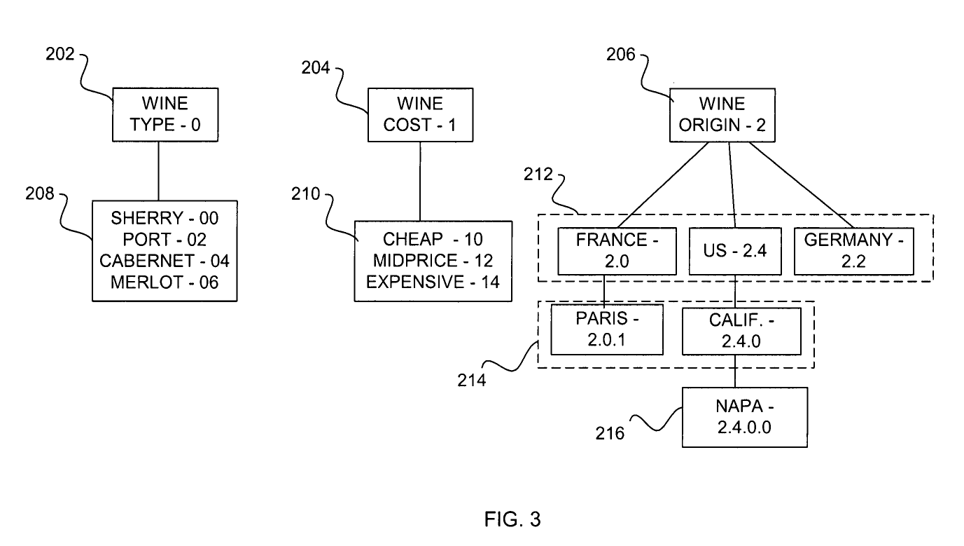

These terms, as well as the step of block 110, may be better understood by reference to FIG. 3 which schematically illustrates the result of the operation of the step of block 110 for the exemplary method directed to creating and retrieving data entries for the wines Wine 1-Wine 4. In FIG. 3, the plurality of categories include “wine type” 202, “wine cost” 204, “wine origin” 206, and individual categories arranged on hierarchical levels below these categories. “Wine type” individual categories are described in the box 208, and include sherry, merlot, port, and cabernet. “Wine cost” individual categories are contained in the box 210, and include cheap, midprice, and expensive. “Wine origins” are further organized into more than one hierarchical level as shown. For example, a plurality of descending levels describe a place of origin as the US on a first descending level (illustrated as dashed line box 212) linked to the “wine origin” category 206, California on a second descending level (illustrated as dashed line box 214) linked to the level 212, and Napa Valley on a third descending level 216 linked to the level 214.

Referring once again to the flowchart of FIG. 2, a subsequent method step includes assigning a category identifier to each of the categories (block 112). The category identifiers are preferably character strings comprised of numbers, letters, and/or other symbols and characters commonly available with computer and programming tools. Other identifiers are also contemplated. This step may be illustrated by consideration of FIG. 3, and Table 2 below

TABLE 2
Categories and Identifiers for Wine Example

| Category | Identifier |
|---|---|
| Wine Type | 0 |
| Sherry | 00 |
| Port | 02 |
| Cabernet | 04 |
| Merlot | 06 |
| Wine Price | 1 |
| Cheap | 10 |
| Midprice | 12 |
| Expensive | 14 |
| Wine Origin | 2 |
| France | 2.0 |
| Paris | 2.0.1 |
| US | 2.4 |
| Calif | 2.4.0 |
| Napa | 2.4.0.0 |
| Germany | 2.2 |

With reference to Table 2 and FIG. 3, it can be seen that each category identifier includes the category identifier for every category that is linked thereto on a higher hierarchical level. As used herein, the term “higher hierarchical level” is intended to be broadly interpreted as a set, with the “level” being a subset. For example, the Napa identifier of 2.4.0.0 includes the California identifier of 2.4.0, the US identifier of 2.4, and the place of origin identifier of 2. That is, Napa is a “subset” of the higher hierarchical level California. The category identifiers may be stored in a look-up table. As used herein, the term “look-up table” is intended to be broadly interpreted as a storage for information that includes some relational or cross-reference aspect. A look-up table may comprise, by way of example only, data in a spreadsheet, table, or similar format.

The method next includes the step of creating a plurality of data records for a plurality of data entries (block 114). Each of the data entries has at least one attribute that corresponds to one of the categories. Steps of using the category look-up table may be included in creating the data entries. Referring again to the wine example, the wines Wine1-Wine4 listed in Table 1 may be considered to be the data entries. Following the step 114 of the invention, a plurality of data records for these data entries will be created as summarized in Table 3:

TABLE 3
Example Wine Data Entries and Data Records

| Wine: | Data Record: |
|---|---|
| Wine1 | 00 10 2.0.1 2.2 |
| Wine2 | 02 14 2.0 |
| Wine3 | 04 12 2.4.0 |
| Wine4 | 06 14 2.4.0.0 |

As shown by Table 3, each of the data entries includes category identifiers for the categories that correspond to attributes of the respective wines. As used herein, the term “attribute” is intended to be broadly interpreted as meaning a quality, characteristic, trait, or the like.

The exemplary method of the invention of FIG. 2 next includes the step of receiving a query that corresponds to one or more of the categories (block 116). Referring again to the wine example, a query may be: “what wines are from the US?” In response to this query, the method of FIG. 2 performs the step of retrieving the data records that include the category identifier corresponding to the categories included in the query (block 118). With reference to the wine example once again, all of the data records from Table 3 that included the category identifier for the US (2.4) would be retrieved: Wine3 and Wine4.

Methods, systems, and program products of the invention may also include a step of retrieving only a portion of the matching records. For example, for purposes of speed or the like, it may be desirable to retrieve only one or some other limited number of data records having attribute identifiers matching those of a query rather than all of the matching data records.

This simple wine example illustrates some of the valuable advantages and benefits of the present invention. Through a method of the invention, the category identifier of each of the categories embodies implicit knowledge regarding the placement of the category identifier within the hierarchical arrangement of categories. For example, the category identifier for each category includes information showing each linked category. With reference to FIG. 3, the category identifier for each category thus includes a “map” of where the category fits in the hierarchical levels. When these categories are matched with the attributes of data entries and placed in data records corresponding to those data entries, the implicit knowledge of the category identifiers is embodied in the data records. Thus a single data entry for a wine includes a wealth of implicit knowledge as to how that wine “fits into” the overall hierarchical organization of wines. In processing a query, the method of the invention leverages this implicit knowledge to quickly and effectively process queries. Relatively simple and fast query execution can return a great deal of knowledge that might otherwise require multiple queries and/or more complex query processing.

It will be appreciated that the simple wine example has been presented to illustrate operation of an exemplary method of the invention only. In practice, methods of the invention will likely find utility with far more numerous and complex data and queries. By way of example, practice of the invention is not limited to queries having only a single category, but may include a plurality of categories that may be related by Boolean or other logical operators. For example, a query may be expressed using Boolean operators such as: “red wine” not “cheap” not “California.” In such circumstances, methods and systems of the invention may include the additional step of processing the Boolean or other logical operator. Also, it will be understood that methods, systems, and program products of the invention will be useful for practice using data entries, categories, and hierarchical levels of far greater numbers than the simple example illustrated.

In additional embodiments of methods and systems of the invention, steps of weighting are executed. The term “weighting” as used herein is intended to be broadly interpreted as an indication of priority. Weightings may be assigned to all or just a portion of the categories. The basis for these weightings may be provided through external input, such as operator or user choices, or the like.

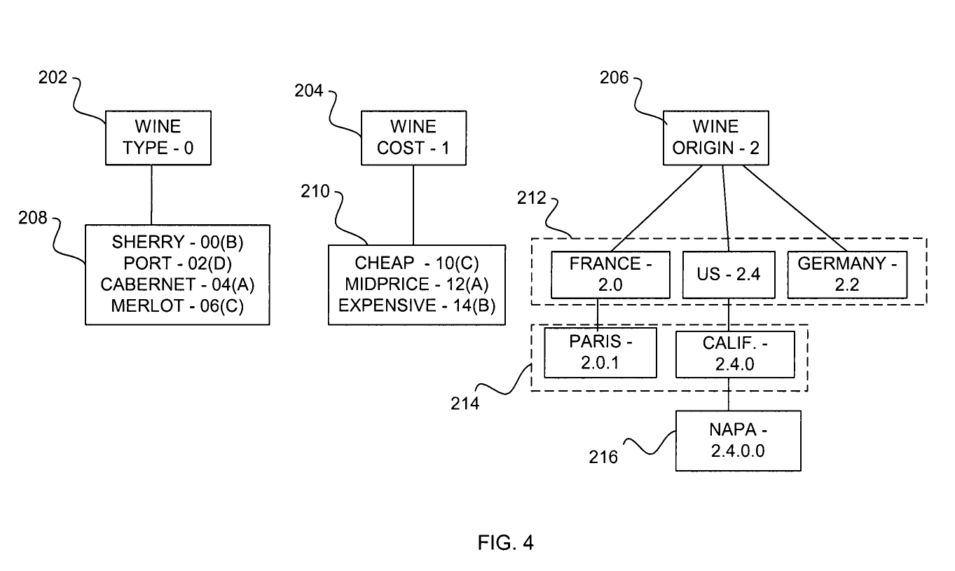

FIG. 4 is a schematic useful in illustrating one exemplary invention embodiment that utilizes weighting. The schematic of FIG. 4 is consistent with that of FIG. 3, except that the wine type categories contained in box 208 and the wine price categories contained in box 210 have been weighted. The weightings are illustrated using alphabetic symbols in parenthesis, with the position in the alphabet representing priority (e.g., from (A) highest to (Z) lowest). Other representations of weighting may also be used, with one example being numbers. The weightings may be included in the respective category identifiers. These weightings can be used to prioritize the data records, with the data records of Wines 1-4 of Table 3 presented in Table 4 with weightings included

TABLE 4
Weighted Data Records

| Wine: | Data Record: |
|---|---|
| Wine1 | 00(B) 10(C) 2.0.1 2.2 |
| Wine2 | 02(D) 14(B) 2.0 |
| Wine3 | 04(A) 12(A) 2.4.0 |
| Wine4 | 06(C) 14(B) 2.4.0.0 |

By way of further illustration, these assigned weightings would indicate that cabernets were favored over all other wine types, followed in order by sherry, merlot, and port.

Methods and systems of the invention may further include steps of using the weightings to respond to queries. By way of example, if the data records of both of Wine3 and Wine4 were responsive to a hypothetical query, a method step of the invention that included consideration of weighting would retrieve Wine3 over Wine4 on the basis of the two (A) weightings of Wine3 as compared to the (C) and (B) weightings of Wine4.

Methods and systems of the present invention also contemplate unique weightings for individual users. By way of example, two different users may put different weightings on wine type. A first user may specify the wine type weightings as listed above in Table 4 and FIG. 4. A second user may specify a different weighting that places sherry above all other types, followed in order by port, merlot, and cabernet (e.g., sherry (A), port (B), merlot (C), and cabernet (D)).

In order to carry out these steps, individual users will be identified, and their weightings stored. By way of example, when the invention is being practiced as a computer program product, a user may be asked for a password, username, or other identifying information. Upon a first use, the user may be requested to provide weightings for one or more categories, and these category weightings stored. Upon a second and subsequent use, the stored weightings for the user may be recalled. Weightings for individual users may be stored in a look-up table.

Methods and systems of the invention also may include steps of modifying weightings based on queries. For example, a method of the invention may include steps of tallying a history of queries, and of adjusting category weightings based on the frequency of the category being requested. Referring to FIG. 4 by way of particular example, the category identifier Cabernet may have been assigned the (A) weighting based on its being the most frequently requested wine type. Steps of adjusting weightings based on queries may likewise be included with regard to individual users.

Methods of the invention further contemplate steps of extending weighting across hierarchical levels and/or categories. For example, when a user selects one particular category, categories linked thereto on different hierarchical levels may be weighted. For example, based on a selection of a California wine, the weighting of the linked hierarchical level of USA may be changed.

### EXAMPLE 2

### Website Classification

Operation, benefits, and advantages of the present invention may be further illustrated through consideration of a hypothetical company website classification. Assume a hypothetical company called HYPCO has a website, or similar network of navigable and related information. As used herein, it will be appreciated that a “website” is intended to broadly refer to a computer based set of navigable information, with a website having related links on the world wide web being a particular example. A method of the invention may be practiced to facilitate organization and access to content of the website. Through a method of the invention, each of the various “pages” on the website may be organized into a plurality of categories and hierarchical levels. Each page in the website may be assigned three categories: subject, object type (News, Views, Events, etc.) and security.

When new content is added to the website, a user may choose a relevant part of the site map to which to add the information. The content may be created as a reusable module or data entry, and inherits the hierarchical identifier of the web page to which it is to be added. For example, assume that Employee wants to add information about herself to the website. She goes to an ‘About HYPCO’ page, and then to a ‘People’ link and clicks “contribute.” She is then prompted for information about herself and a picture. Practice of a method of the invention will include a step of storing her information as a data entry, and assigning it the identifiers 111 (People) and 21 (About HYPCO). At this stage the employee does not need to have any awareness of the underlying categories and hierarchical levels as they have simply navigated the website and clicked a ‘Contribute’ link. The identifiers 111 and 21 include implicit information about the location of these respective categories in the hierarchical structure of categories, however, which can be exploited through the present invention. For instance, category identifier 21 (About HYPCO) may be linked to a higher hierarchical level with the category identifier of 2.

Assume that at some future time the employee will want to reuse the same piece of information somewhere else on the HYPCO website. They might, for example, wish to add their existing profile to another page of the website that describes all of the personnel working on a particular project—the “people” section of a “Johnson project” webpage, for example.

To accomplish this, the employee will review the categories and hierarchical levels organized through the invention, and then add an appropriate identifier to her data entry (e.g., add identifier 312 for “people,” “Johnson project” to her data record). That data entry will then be retrieved through the invention anytime the “people” portion of the “Johnson project” webpage is accessed. Thus the employee has avoided having to re-enter her information, and yet has made it available for another portion of the website.

Over time data entries build up on the system. As users need them to appear in different places in the web page sitemap they add more identifiers to them. In essence, through entry and categorization of data entries a whole knowledge system has been developed, with data entries being described with multiple classifications. The method of the invention has thus embedded intrinsic knowledge with the data entries. The method of the invention also provides steps to exploit this intrinsic knowledge. For example, for an employee's data entry in the webpage some indication of the employee's skills can be determined simply by review of the identifiers associated with the data entry. This info can be easily extracted into new maps to identify people with common skill sets and create new knowledge communities. In this way, driven by practical need, users created an entire knowledge resource which is then ripe to explore in new ways.

Those knowledgeable in the art will appreciate that the present invention may find particular utility when practiced in the form a computer program product. In this form, the invention may include a graphical user interface that assists users in operation of the invention. Also, computer program products of the invention may be practiced using one or more computers communicating with one another over a network.

While particular embodiments of the present invention have been described herein, it will be appreciated by those skilled in the art that changes and modifications may be made thereto without departing from the invention in its broader aspects and as set forth in the following claims.

1. A method for creating and retrieving data records comprising the steps of:
organizing a plurality of categories into a plurality of hierarchical levels;
assigning a category identifier to each respective of said plurality of categories, said category identifier including the identifier for each category linked to said each respective category in each of said plurality of hierarchical levels that is above said level of said each respective category;
creating a plurality of data records for a plurality of data entries, each of said data entries having at least one attribute that corresponds to one of said categories;
storing said category identifier that corresponds to said at least one attribute of each particular data entry in said data record for said particular data entry;
receiving a query that corresponds to one or more of said categories; and,
retrieving at least one of said data records that include a category identifier corresponding to said query.

2. A method for creating and retrieving data records as defined by claim 1 and further including the step of storing said category identifiers in a look-up table, and using said look-up table to create said data records and to process said query.

3. A method for creating data records as defined by claim 1 wherein said character identifiers comprise alphanumeric strings.

4. A method for creating and retrieving data records as defined by claim 1 wherein said query corresponds to a plurality of categories related by at least one Boolean logic operator.

5. A method for creating and retrieving data records as defined by claim 1 and further including the steps of assigning a weighting to at least a portion of said categories.

6. A method for creating and retrieving data records as defined by claim 5 wherein the method further includes the step of using said weightings to respond to said query.

7. A method for creating and retrieving data records as defined by claim 6 wherein the step of using said weightings comprises selecting one of said data records containing a higher weighted category identifier that corresponds to said one or more category contained in said query over a second of said data records that contains a lower weighted category identifier that corresponds to said one or more category contained in said query.

8. A method for creating and retrieving data records as defined by claim 5 and further including the step of including said weighting in said category identifier.

9. A method for creating and retrieving data records as defined by claim 5 wherein said weighting is represented by at least one alphanumeric character.

10. A method for creating and retrieving data records as defined by claim 5 wherein the method further includes the step of using said query to modify at least one of said weightings.

11. A method for creating and retrieving data records as defined by claim 1 wherein said query includes a user identifier, and wherein the method further includes the step of using said query to determine a category weighting for said user.

12. A method for creating and retrieving data records as defined by claim 11 and further including the steps of storing said user category weightings in a user look-up table that includes user category weightings for a plurality of users.

13. A method for creating and retrieving data records as defined by claim 11 wherein the step of using said query to determine a category weighting for said user comprises changing a stored user weighting for categories contained in said query.

14. A computer program product embodying the method of claim 1, the computer program product including computer executable instructions embedded in a computer readable medium that when read by a computer cause the computer to execute the steps of the method.

15. A computer program product as defined by claim 14, wherein the program instructions when executed further cause the computer to provide a graphical user interface.

16. A method for creating and retrieving data records as defined by claim 1 wherein each of said category identifier embody implicit knowledge regarding the placement of the category identifier within said hierarchical arrangement of categories.

17. A method for creating data records comprising the steps of:
creating a hierarchical structure of a plurality of categories linked over a plurality of descending levels;
assigning a category identifier to each respective of said plurality of categories, said category identifier corresponding to one of said plurality of descending levels and including the identifier for each category linked thereto in each of said plurality of levels that is above said level of said each respective category to thereby embody implicit knowledge in said category identifier;
creating a data record for each of a plurality of data entries, each of said data entries having a plurality of attributes that correspond to one each of said categories;
storing said category identifiers that correspond to said attributes of said each respective data entry in said data record of said respective data entry; and,
applying a weighting to at least a portion of said categories.

18. A computer program product for creating and retrieving data records, the program product including computer executable instructions stored on a computer readable medium, the executable steps when executed causing a computer to:
create a hierarchical structure of a plurality of categories linked over a plurality of descending levels;
assign a category identifier to each respective of said plurality of categories, said category identifier including the identifier for each category linked to said each respective category in each of said plurality of levels that is above said level of said each respective category;
create a plurality of data records for a plurality of data entries, one each of said plurality of data records corresponding to one each of said plurality of data entries, each of said data entries having at least one attribute that corresponds to one of said categories;
store said category identifier that correspond to said at least one attribute of each particular data entry in said data record for said particular data entry;
receive a query that corresponds to one or more of said categories; and,
retrieve all of said data records that include a category identifier corresponding to said query.

19. A computer program product as defined by claim 18 wherein the executable instructions when executed further cause said computer to apply a weighting to at least a portion of said categories, said weighting operative to rank said categories within one of said plurality of levels.

20. A computer program product as defined by claim 18 wherein said query includes a user identifier, and wherein the executable instructions when executed further cause said computer to modify a stored user weighting corresponding to said user identifier in said query and based on said categories specified in said query.

21. A computer program product as defined by claim 18 wherein said query corresponds to a particular category on a particular level, and wherein the executable instructions cause the computer to retrieve all of said data records that include said category identifier for categories linked to said particular category on levels below said particular level.
